(19) United States
(12) Patent Application Publication
(10) Pub. No.: US 2003/0082954 A1
(43) Pub. Date: May 1, 2003

(54) Cross-talk reduced modular jack

(76) Inventors: Leonard K. Espenshade, Harrisburg, PA (US); David F. Givens, Harrisburg, PA (US); Timothy B. Billman, Dover, PA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/002,366

(22) Filed: Nov. 1, 2001

(51) Int. Cl. H01R 24/00

(52) U.S. Cl. 439/676

(57) ABSTRACT

An electrical connector (1) includes an insulative housing (2), a conductive shield (3) enclosing the insulative housing and a contact insert (4, 4′). The contact insert has a number of electrical contacts (41-48, 41′-48′) arranged into differential pairs. A first electrical contact of a first differential pair electrically couples with a first electrical contact of a second differential pair to balance an electrical coupling between a second electrical contact of the first differential pair and the first electrical contact of the second differential pair.

### BACKGROUND OF THE INVENTION

1. Field of the Invention

The present invention relates to an electrical connector, and particularly to a cross-talk reduced modular jack.

2. Description of the Related Art

Cross-talk can be generally described as the unwanted coupling of electrical signals on adjacent signal lines. Such cross-talk may result in portion of an electrical signal on one pair of lines appearing on a separate pair of lines as unwanted noise.

Cross-talk between different pairs of wires is a source of interference that can cause signal degradation and negatively impact the ability of a communication system to process incoming signals. Cross-talk can also increase error rates and reduce signal strength.

Problems associated with unwanted cross-talk are becoming even more problematic given the general increase in operating frequencies and data rates of modern communication systems. Additionally, cross-talk can be particularly problematic within electrical connectors, e.g., modular jacks, that contain a plurality of contacts that are generally parallel and spaced closely together-a configuration that may lead to excessive cross-talk even over short lengths.

The modular jacks are always subject to a variety of industry signal transmission protocols, such as 10 BaseT protocol, 100 BaseT protocol and 1000 BaseT protocol. Modular jacks capable of operating in either 10 BaseT protocol or 100 BaseT protocol (i.e., 10/100 BaseT protocol) are commonplace and some modular jacks are entering the 10/1000 BaseT protocol arena, but the market is driven to modular jacks capable of operating at either 10/100 or 10/1000 BaseT protocol.

It is well known to all skilled in the pertinent art that different methods of compensation to reduce or eliminate the cross-talk have been successful in both 10/100 BaseT protocol and 10/1000 BaseT protocol. However, the different electrical pairing arrangement of the electrical contacts for compensation between 10/100 BaseT protocol modular jack and 10/1000 BaseT protocol modular jack makes the compensation in a commoned 10/100 and 10/1000 BaseT protocol modular jack much more difficult. Ideal compensation in the 10/100 protocol could result in worse than no compensation performance when the modular jack is called upon to perform in the 10/1000 BaseT protocol, and vice versa.

Furthermore, conventional modular jacks with cross-talk reduced electrical contacts are always difficult and expensive to manufacture.

Therefore, an improved electrical connector solving or obviating the aforementioned problems is desired.

### SUMMARY OF THE INVENTION

A first object of the present invention is to provide an electrical connector which effectively reduces cross-talk between electrical contacts thereof.

A second object of the present invention is to provide an economically and manufacturably feasible electrical connector conforming to either 10/100 or 10/1000 BaseT protocol.

An electrical connector in accordance with the present invention comprises an insulative housing defining a receiving cavity, a conductive shield enclosing the insulative housing and a contact insert accommodated in the receiving cavity of the insulative housing. The contact insert comprises a plurality of electrical contacts each comprising a contacting portion resiliently extending in the receiving cavity of the insulative housing and a tail portion extending beyond the insulative housing. A transitional portion or a conductive trace connects the contacting portion and the tail portion of each electrical contact. The transitional portions or conductive traces of a first group of electrical contacts are located in a first horizontal plane and the transitional portions or conductive traces of a second group of electrical contacts are located in a second horizontal plane vertically offset or spaced from the first horizontal plane. The transitional portions or conductive traces of the first group of electrical contacts are to some extent vertically overlapped or aligned with the transitional portions or conductive traces of the second group of electrical contacts.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is a view similar to FIG. 1 but taken from a different perspective;

FIG. 3 is a perspective view of an insulative housing of the electrical connector of FIG. 1;

FIG. 4 is a view similar to FIG. 3, but taken from another perspective;

FIG. 5 is a perspective view of a contact insert of the electrical connector of FIG. 1 in accordance with a first embodiment of the present invention;

FIG. 6 is a view similar to FIG. 5 but an insulative portion of the contact insert is removed away;

FIG. 7 is a top plan view of FIG. 6;

FIG. 8 is a front view of FIG. 6;

FIG. 9 is a rear view of FIG. 6;

FIG. 10 is a side elevational view of FIG. 6;

FIG. 11 is a perspective view of a second group of the electrical contacts of FIG. 6;

FIG. 12 is a perspective view of a contact insert of the electrical connector of FIG. 1 in accordance with a second embodiment of the present invention; and

FIG. 13 is a perspective view of a printed circuit board of the contact insert of FIG. 12 showing a second plane thereof.

### DETAILED DESCRIPTION OF THE INVENTION

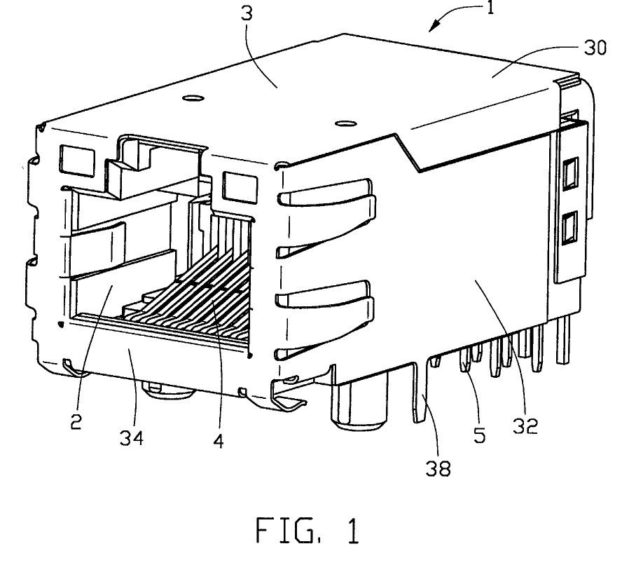

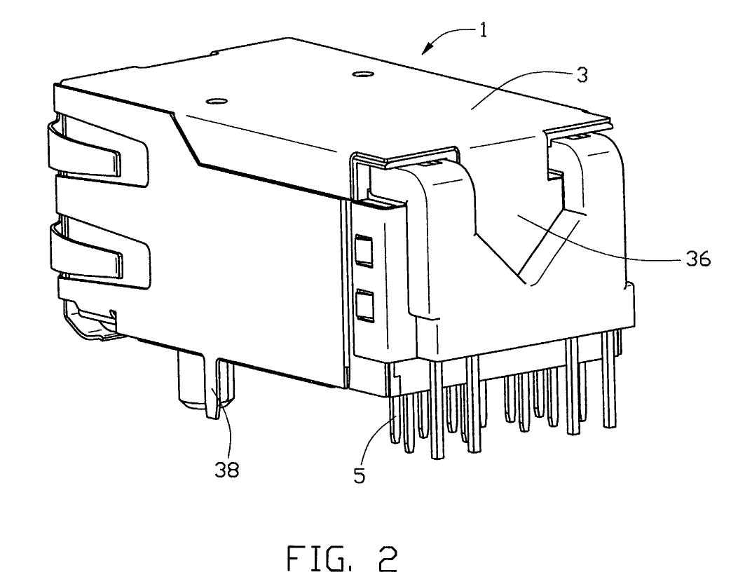

Referring to FIGS. 1 and 2, an electrical connector 1, such as a modular jack, in accordance with a first embodiment of the present invention comprises an insulative housing 2, a conductive shield 3 enclosing the insulative housing 2 and a contact insert 4.

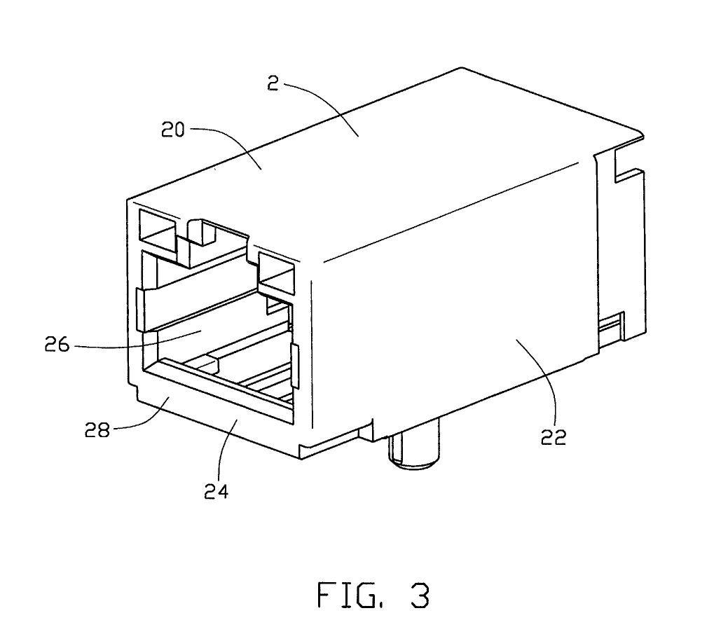

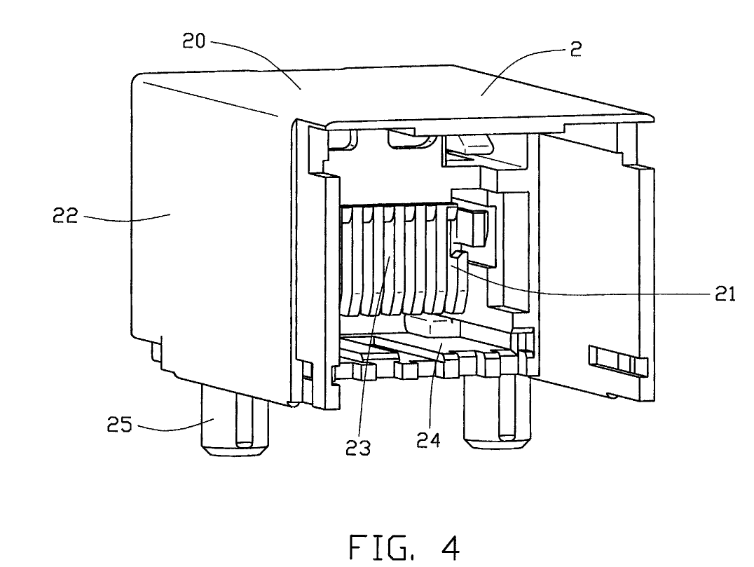

Referring also to FIGS. 3 and 4, the insulative housing 2 comprises a top wall 20, a pair of opposite side walls 22 and a bottom wall 24 opposite to and connected by the side walls 22 to the top wall 20. The insulative housing 2 defines a receiving cavity 26 recessed from a front surface 28 thereof and confined by the top, side and bottom walls 20, 22, 24 thereof for receiving a plug or complementary electrical connector (not shown) therein. A comb-shaped mid-wall 21 extends vertically in a lower and rear portion of the receiving cavity 26 and is perpendicular to the top, side and bottom walls 20, 22, 24. A plurality of spaced channels 23 extend upwardly from a lower end of the mid-wall 21 to an upper portion of the mid-wall 21 and communicate with the receiving cavity 26. A pair of positioning posts 25 extend downwardly from a front portion of the bottom wall 24 to be insertable into for example through holes of a printed circuit board (not shown) when the electrical connector 1 is mounted to the printed circuit board.

The conductive shield 3 comprises a top wall 30 and a pair of opposite side walls 32 corresponding to the top and the side walls 20, 22 of the insulative housing 2, respectively. The conductive shield 3 comprises a front wall 34 corresponding to the front surface 28 of the insulative housing 2 and having an opening corresponding to the receiving cavity 26. A rear wall 36 is formed on the conductive shield 3 and is connected to the top and side walls 30, 32. A pair of grounding tabs 38 (only one shown) extend downwardly from lower edges of the side walls 32.

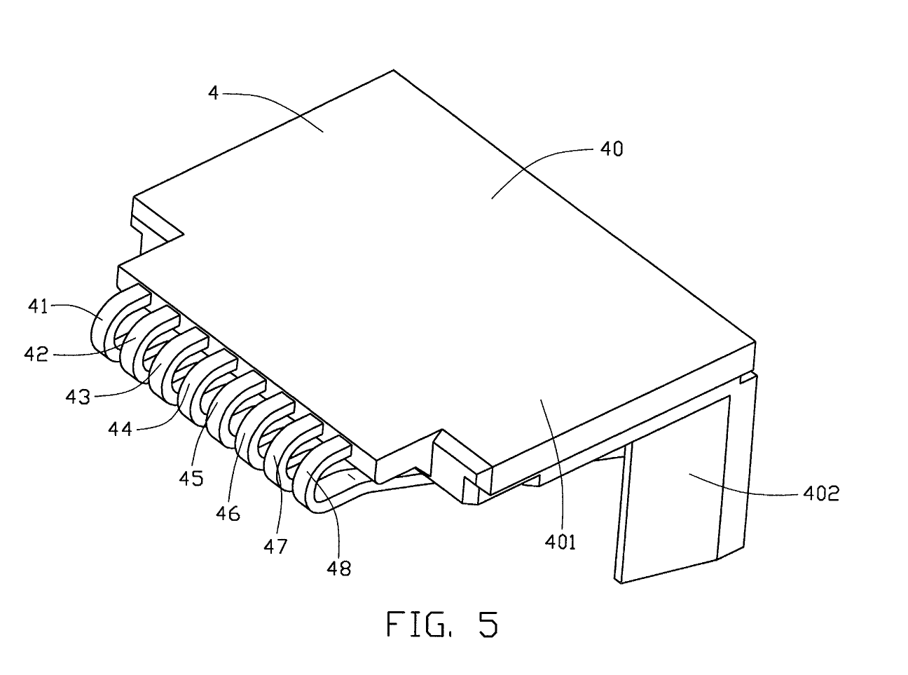

Referring also to FIG. 5, the contact insert 4 comprises an insulative portion 40 and eight electrical contacts 41-48. The insulative portion 40 comprises a horizontal section 401 and a vertical section 402 extending downwardly and perpendicularly from a rear portion of the horizontal section 401.

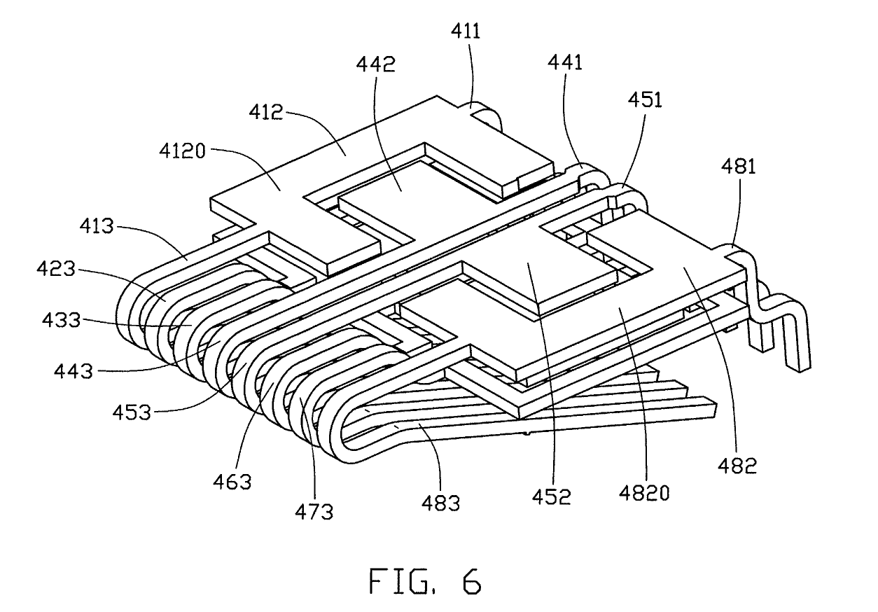

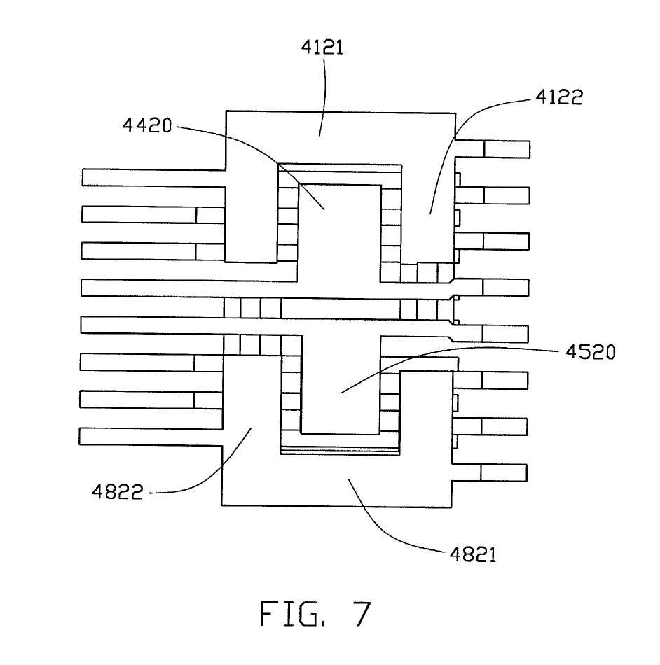

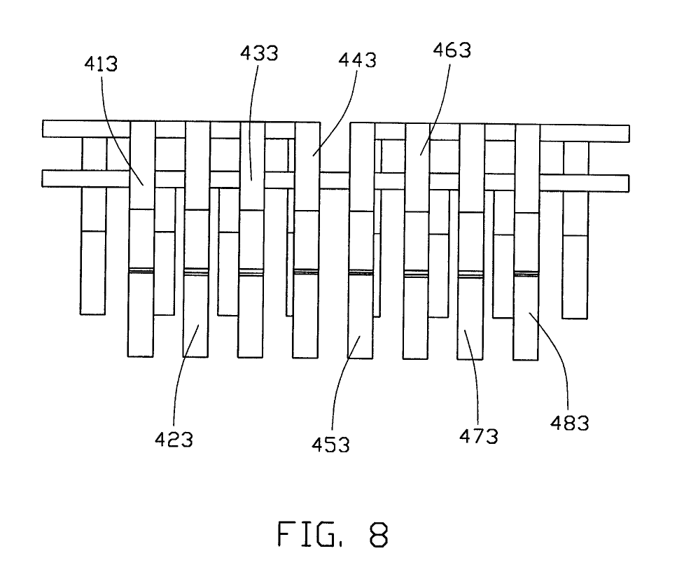

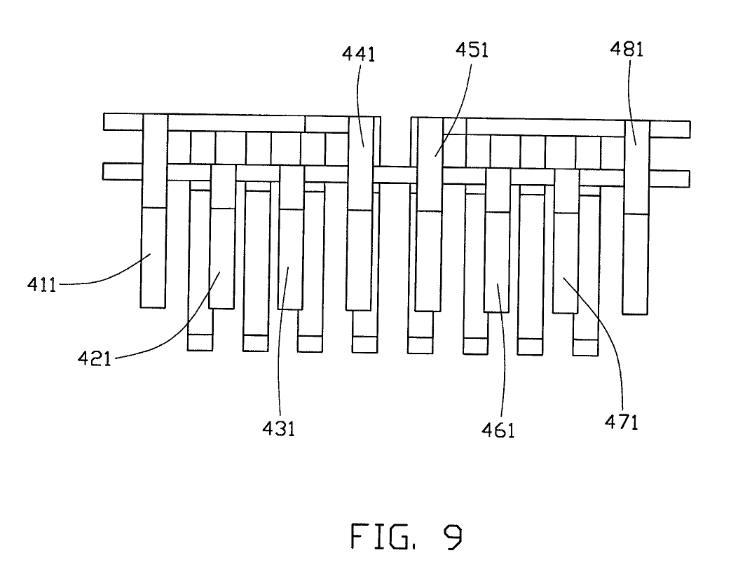

Referring specifically to FIGS. 6-11, the electrical contacts 41-48 each comprise a tail portion 411, 421, 431, 441, 451, 461, 471, 481 for electrically contacting with the printed circuit board on which the electrical connector 1 is mounted, a transitional portion 412, 422, 432, 442, 452, 462, 472, 482 extending forwardly from the tail portion 411, 421, 431, 441, 451, 461, 471, 481, and a contacting portion 413, 423, 433, 443, 453, 463, 473, 483 extending downwardly and rearwardly from the transitional portion 412, 422, 432, 442, 452, 462, 472, 482.

The transitional portions 412, 442, 452, 482 of a first group of contacts 41, 44, 45, 48 are generally located in a horizontal plane from which the contacting portions 413-483 and the tail portions 411, 441, 451, 481 extend away.

Each of the transitional portions 412 and 482 comprises a generally U-shaped plate section 4120, 4820. Each U-shaped plate section 4120, 4820 comprises a base plate 4121, 4821 extending in a front-to-back direction along which the plug complementary connector is inserted into the electrical connector 1 and a pair of leg plates 4122, 4822 extending in a direction perpendicular to the front-to-back direction along which the base plate 4121, 4821 extends. Each base plate or leg plate has a width larger than other portions of a corresponding electrical contact.

Each transitional portion 442, 452 comprises a generally rectangular plate section 4420, 4520 extending laterally from one side thereof into the U-shaped plate sections 4120, 4820, respectively, and substantially surrounded by the base plates 4121, 4821 and the leg plates 4122, 4822.

The transitional portions 422, 432, 462, 472 of a second group of electrical contacts 42, 43, 46, 47 extend firstly rearwardly from the contacting portions 423, 433, 463, 473 in the horizontal plane in which the transitional portions 412, 442, 452, 482 are located and then downwardly to form lower sections 4220, 4320, 4620, 4720 located in another horizontal plane in parallel proximity to the horizontal plane in which the transitional portions 412, 442, 452, 482 are located.

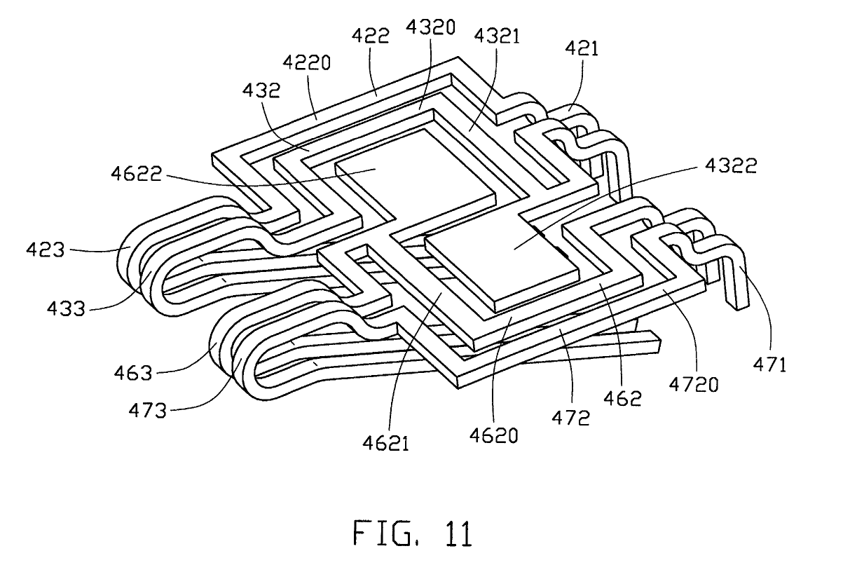

The lower sections 4220 and 4720 extend respectively first outwardly and laterally to be perpendicular to the front-to-back direction along which the plug complementary connector is inserted into the electrical connector 1, then rearwardly to be parallel to the insertion direction of the plug complementary connector, and then inwardly and laterally to be again perpendicular to the insertion direction of the plug complementary connector and to perpendicularly connect with the tail portions 421, 471. Thus, the lower sections 4220, 4720 are generally U-shaped and as could be clearly seen from FIG. 11, the U-shaped sections 4220, 4720 have widths substantially equal to widths of other portions of the electrical contacts 42, 47. The U-shaped sections 4220, 4720 are vertically overlapped by the U-shaped plate sections 4120, 4820, respectively.

Each of the lower sections 4320, 4620 is also formed with a generally U-shaped section 4321, 4621 generally surrounded by the U-shaped lower sections 4220, 4720, respectively, and substantially vertically overlapped by the U-shaped plate sections 4120, 4820, respectively. A rectangular plate section 4322, 4622 diverges from a leg end of the U-shaped sections 4321, 4621 to extend into a corresponding U-shaped section 4621, 4321 of a corresponding transitional portion 462, 432 and to vertically align with the rectangular plate sections 4520, 4420, respectively.

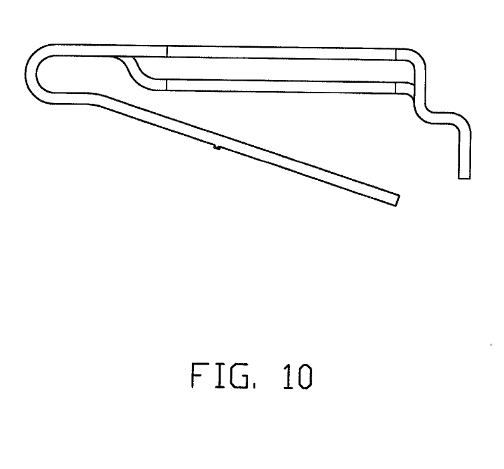

The tail portions 421, 431, 461, 471 of the second group of electrical contacts 42, 43, 46, 47 extend downwardly a shorter distance from the transitional portions 422, 432, 462, 472 than the tail portions 411, 441, 451, 481 extend downwardly from the transitional portions 412, 442, 452, 482 of the first group of electrical contacts 41, 44, 45, 48, such that lower ends of the first and second groups of electrical contacts 41-48 are, as specifically shown in FIGS. 6 and 10, located in the same level.

The electrical contacts 41-48 are insert molded in the insulative portion 40 to form the contact insert 4. The transitional portions 412-482 are embedded in the horizontal section 401 in two aforementioned different planes (levels), the contacting portions 413-483 extend resiliently and slantways beyond a front end of the insulative portion 401, and the tail portions 413-483 extend beyond the vertical section 402.

In assembly, the contact insert 4 is inversely inserted in a back-to-front direction into the receiving cavity 26 of the insulative housing 2 with the contacting portions 413-483 respectively movably received in the channels 23 of the mid-wall 21. The tail portions 411-481 are electrically connected to terminals 5 (FIGS. 1 and 2) in ways well known to any one of ordinary skill in the pertinent art to be electrically engaged with the printed circuit board on which the electrical connector 1 is mounted, so a detailed description thereabout is omitted herefrom.

As stated above, the U-shaped plate sections of the transitional portions of the electrical contacts 41, 48 vertically overlap (align with) the U-shaped sections of the transitional portions of the electrical contacts 42 and 43, 46 and 47, respectively. The rectangular plate sections 4420 and 4520 of the transitional portions 442 and 452 of the electrical contacts 44 and 45 vertically overlap and/or align with the rectangular plate sections 4622 and 4322 of the transitional portions 462 and 432 of the electrical contacts 46 and 43, respectively. Through such arrangement, the electrical contacts 42 and 44, 44 and 46, 46 and 48 are located closer in a horizontal direction than when the transitional portions 412-482 are located in turn side by side in a common horizontal plane.

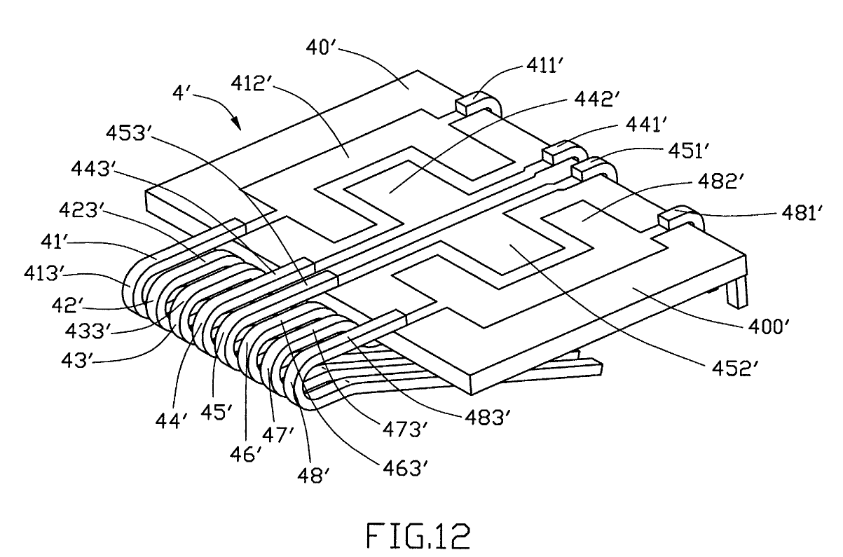

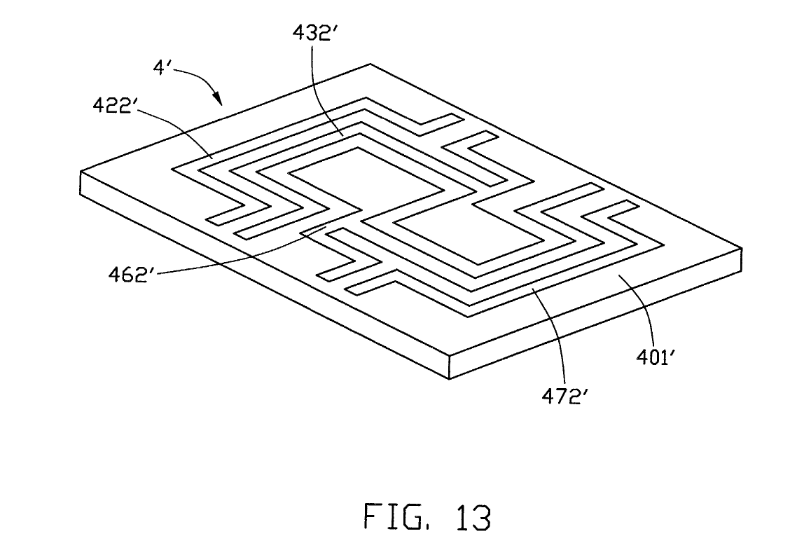

Referring to FIGS. 12 and 13, a contact insert 4′ in accordance with a second embodiment of the present invention comprises eight electrical contacts 41′-48′ and a printed circuit board 40′. The electrical contacts 41′-48′ respectively comprise tail portions 411′-481′ (only 411′, 441′, 451′ and 481′ shown) and contacting portions 413′-483′. The printed circuit board 40′ comprises a first plane 400′ and a second plane 401′. The first plane 400′ defines a plurality of conductive traces 412′, 442′, 452′ and 482′ thereon corresponding to the electrical contacts 41′, 44′, 45′ and 48′, respectively, and the second plane 401′ defines a plurality of conductive traces 422′, 432′, 462′ and 472′ corresponding to the electrical contacts 42′, 43, 46′ and 47′, respectively. The conductive traces 412′-482′ are electrically connected with the tail and the contacting portions 411′-481′, 413′-483′ of the electrical contacts 41′-48′, respectively. The shapes of the conductive traces 412′-482′ correspond to those of the transitional portions 412-482 of the electrical contacts 41-48, respectively, and the overlapping relations between the conductive traces 412′-482′ is identical to those between the transitional portions 412-482.

In use, when the electrical connector 1 needs to work in 10/100 BaseT protocol, desired electrical couplings could be established in the respective differential contact pairs of 41 and 42 (41′ and 42′), 43 and 46 (43′ and 46′), 44 and 45 (44′ and 45′) and of 47 and 48 (47′ an 48′). Unwanted electrical couplings (cross-talks), such as between the electrical contacts 42 and 43 (42′ and 43′) and between the electrical contacts 46 and 47 (46′ and 47′) are balanced by electrical couplings between the electrical contacts 41 and 43 (41′ and 43′) and between the electrical contacts 46 and 48 (46′ and 48′), respectively achieved by the vertical overlapping of the U-shaped sections thereof. Also, unwanted electrical couplings between the electrical contacts 43 and 44 (43′ and 44′) and between the electrical contacts 46 and 45 (46′ and 45′) are balanced by the electrical couplings between the electrical contacts 43 and 45 (43′ and 45′) and between the electrical contacts 46 and 44 (46′ and 44′) respectively achieved by the vertical overlapping of the rectangular-shaped plate sections thereof. Thus, the cross-talk of the electrical contacts 41-48 of the electrical connector 1 is effectively reduced.

When the electrical connector 1 needs to work in 10/1000 BaseT protocol, desired electrical couplings could be established in the respective differential contact pairs of 41 and 42 (41′ and 42′), 43 and 44 (43′ and 44′), 45 and 46 (45′ and 46′) and of 47 and 48 (47′ and 48′). Unwanted electrical couplings, such as between 42 and 43 (42′ and 43′), between 44 and 45 (44′ and 45′) and between 46 and 47 (46′ and 47′) would also be balanced by electrical couplings between 41 and 43 (41′ and 43′), between 43 and 45 (43′ and 45′) and between 46 and 48 (46′ and 48′), respectively established in like ways as described above. So cross-talk of the electrical contacts 41-48 is also effectively reduced.

Thus, the electrical connector 1 is capable of working in either 10/100 BaseT protocol or 10/1000 BaseT protocol.

As clearly shown in FIGS. 6 and 11, shapes and dimension of the transitional portions 412, 442, 452, 482 of the first group of electrical contacts 41, 44, 45, 48 are complementary with one another and shapes and dimension of the transitional portions 422, 432, 462, 472 of the second group of electrical contacts 42, 43, 46, 47 are complementary with each other, so the first and second groups of electrical contacts could be respectively stamped from one separate metal sheet with little material waste, thereby reducing the manufacturing cost thereof and simplifying the manufacturing procedures thereof.

Furthermore, the contact insert 4, 4′ is configured as one unit, the insulative housing 2 needs not consider designing complicated infrastructure to correspond to the varying shapes and dimension of the electrical contacts 41-48 (41′-48′). Therefore, the manufacturing cost of the insulative housing 2 is also reduced.

Although the conductive traces 412′-482′ shown in FIGS. 12 and 13 are directly connected with the electrical contacts 41′-48′, they also can be connected to other electronic components, for example capacitors and magnetic. Furthermore, the electrical connector 1 shown herein is a singular port connector, while it could be in multi-port connector, such as side by side and stacked connector fashion, if desired.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a receiving cavity; and
a contact insert being received in the receiving cavity of the insulative housing and including a plurality of electrical contacts comprising portions arranged in an upper and a lower levels, the electrical contacts being arranged into differential pairs, a first electrical contact of a first differential pair electrically coupling with a second electrical contact of the first differential pair while simultaneously electrically coupling with a first electrical contact of a second differential pair to balance an electrical coupling between the first electrical contact of the second differential pair and the second electrical contact of the first differential pair, a contacting portion of the first electrical contact of the second differential pair and a contacting potion of the second electrical contact of the first differential pair being adjacent to each other in one of the upper and lower levels.

2. The electrical connector as claimed in claim 1, wherein each of the electrical contacts comprises the contacting portion, a transitional portion and a tail portion and wherein the contacting portions extend from the one of the upper and lower levels.

3. The electrical connector as claimed in claim 2, wherein the transitional portions of the first and the second electrical contacts of the first differential pair are located in the upper and the lower levels, respectively.

4. The electrical connector as claimed in claim 2, wherein the transitional portions of the first and the second electrical contacts of the first differential pair are located in one of the upper and the lower levels.

5. The electrical connector as claimed in claim 2, wherein the contact insert comprises an insulative portion in which the electrical contacts are insert molded, the insulative portion comprising a horizontal portion beyond which the contacting portions extend and a vertical portion perpendicular to the horizontal portion beyond which the tail portions extend.

6. The electrical connector as claimed in claim 2, wherein the transitional portion of the first electrical contact of the first differential pair is a generally U-shaped plate located in the upper level and the transitional portion of the second electrical contact of the first differential pair is generally U-shaped located in the lower level to vertically align with the transitional portion of the first electrical contact of the first differential pair.

7. The electrical connector as claimed in claim 2, wherein the transitional portions of the first and a second electrical contacts of the second differential pair are located in the upper and the lower levels, respectively, and each comprise a rectangular plate section vertically offset from each other.

8. The electrical connector as claimed in claim 2, wherein the transitional portions of the first and a second electrical contacts of the second differential pair are located in one of the upper and the lower levels and each comprise a rectangular plate section and a U-shaped section and wherein the rectangular plate section of the first electrical contact are substantially surrounded by the U-shaped section of the second electrical contact while the U-shaped section of the first electrical contact substantially surrounds the rectangular plate section of the second electrical contact.

9. The electrical connector as claimed in claim 2 further comprising a third differential pair spaced from the first differential pair by the first electrical contact of the second differential pair and wherein the transitional portions of a first and a second electrical contacts of the third differential pair are located adjacent to each other in one of the upper and the lower levels and each comprise an outwardly and laterally extending rectangular plate section.

10. An electrical connector comprising:
an insulative housing defining a receiving cavity; and
a plurality of electrical contacts accommodated in the receiving cavity of the insulative housing, each electrical contact comprising a contacting portion, a tail portion extending beyond the insulative housing and a transitional portion connecting the contacting and the tail portions, the transitional portion of a first electrical contact of the plurality of electrical contacts being located in a first horizontal plane and the transitional portions of a second, a third and a fourth electrical contacts of the plurality of electrical contacts being located in a second horizontal plane in parallel proximity to the first horizontal plane, the first and the second electrical contacts and the third and the fourth electrical contacts respectively forming a differential pair, a first electrical coupling between the second and the third electrical contacts being balanced by a second electrical coupling between the first and the third electrical contacts.

11. The electrical connector as claimed in claim 10, wherein the plurality of electrical contacts are insert molded in an insulative portion to form a contact insert received in the receiving cavity of the insulative housing, the insulative portion comprising a horizontal section in which the transitional portions of the electrical contacts are embedded and beyond which the contacting portions of the electrical contacts extend, and a vertical section perpendicular to the horizontal section and beyond which the tail portions of the electrical contacts extend.

12. The electrical connector as claimed in claim 10 further comprising a conductive shield enclosing the insulative housing.

13. An electrical connector comprising:
an insulative housing defining a receiving cavity; and
a first through eighth electrical contacts accommodated in the receiving cavity of the insulative housing, each of the first through eighth electrical contacts comprising a contacting portion arranged in a first to eighth side-by-side array, a tail portion extending beyond the insulative housing, and a transitional portion connecting the contacting portion and the tail portion, the transitional portions of the first, the fourth, the fifth and the eighth electrical contacts being located in a first horizontal plane from which the contacting portions of all of the eight electrical contacts extend and from which the tail portions of the first, the fourth, the fifth and the eighth electrical contacts extend, the transitional portions of the second, the third, the sixth and the seventh electrical contacts being located in a second horizontal plane parallel to the first horizontal plane.

14. The electrical connector as claimed in claim 13, wherein each of the transitional portions of the first and the eighth electrical contacts comprises a U-shaped plate section and each of the second and the seventh electrical contacts are generally U-shaped and are vertically overlapping the U-shaped plate sections of the first and the eighth electrical contacts.

15. The electrical connector as claimed in claim 14, wherein each of the transitional portions of the third and the sixth electrical contacts comprises a U-shaped section surrounded by the U-shaped sections of the second and the seventh electrical contacts, respectively and vertically overlapped by the U-shaped plate sections of the first and the eighth electrical contacts, respectively.

16. The electrical connector as claimed in claim 13, wherein each of the transitional portions of the third and the sixth electrical contacts comprises a U-shaped section and a rectangular plate section, the rectangular plate sections of the transitional portions of the third and the sixth electrical contacts extending into and surrounded by the U-shaped sections of the transitional portions of the sixth and the third electrical contacts, respectively.

17. The electrical connector as claimed in claim 16, wherein each of the transitional portions of the fourth and the fifth electrical contacts comprises a rectangular plate section vertically aligned with the rectangular plate sections of the sixth and the third electrical contacts, respectively.

18. The electrical connector as claimed in claim 13, wherein the first to eighth electrical contacts are insert molded in an insulative portion and wherein the insulative portion comprises a horizontal section in which the transitional portions of the first to the eighth electrical contacts are embedded and from which the contacting portions of the first to the eighth electrical contacts extend, and a vertical section which is perpendicular to the horizontal section and from which the tail portions of the first to the eighth electrical contacts extend.

19. The electrical connector as claimed in claim 13 further comprising a conductive shield enclosing the insulative housing.

20. An electrical connector comprising:
an insulative housing defining a receiving cavity; and
a contact insert received in the receiving cavity of the insulative housing, the contact insert comprising an insulative portion and a plurality of electrical contacts, each electrical contact comprising a transitional portion insert molded in the insulative portion, a contacting portion extending from the transitional portion beyond the insulative portion into the receiving cavity of the insulative housing, and a tail portion extending from the transitional portion beyond the insulative portion of the contact insert and beyond the insulative housing, the transitional portions of a first and a second electrical contacts of the plurality of electrical contacts being located in a first horizontal plane and the transitional portions of a third and a fourth electrical contacts of the plurality of electrical contacts being located in a second horizontal plane parallel to the first horizontal plane, the first and the third electrical contacts and the second and the fourth electrical contacts being arranged into a first and a second differential pairs, respectively, the first electrical contact of the first differential pair vertically aligning with the fourth electrical contact of the second differential pair to establish an electrical coupling therebetween to balance an electrical coupling between the third electrical contact of the first differential pair and the fourth electrical contact of the second differential pair which is located adjacent to the third electrical contact of the first differential pair.

21. The electrical connector as claimed in claim 20 further comprising a conductive shield enclosing the insulative housing.

22. The electrical connector as claimed in claim 20, wherein the insulative portion comprises a horizontal section from which the contacting portions of the electrical contacts extend and a vertical section perpendicular to the horizontal section, the tail portions of the electrical contacts extending beyond the vertical section.

23. An electrical connector comprising:
an insulative housing defining a receiving cavity for receiving a mating connector; and
a contact insert received in the receiving cavity of the insulative housing, the contact insert comprising a printed circuit board having conductive traces and a plurality of electrical contacts assembled to the printed circuit board, the electrical contacts having contacting portions extending into the receiving cavity of the insulative housing, the electrical contacts electrically connecting to the conductive traces of the printed circuit board, respectively;
the electrical contacts being electrically arranged into differential pairs;
a first conductive trace of the conductive traces that connects with a first electrical contact of a first differential pair extending over both a second conductive trace of the conductive traces that connects with a second electrical contact of the first differential pair and a first conductive trace of the conductive traces that connects with a first electrical contact of a second differential pair, wherein the second electrical contact of the first differential pair is adjacent to the first electrical contact of the second differential pair;
wherein an electrical coupling between the second conductive trace of the first differential pair and the first conductive trace of the second differential pair is balanced by an electrical coupling between the first conductive trace of the first differential pair and the first conductive trace of the second differential pair.

24. An electrical connector comprising:
an insulative housing defining a lengthwise direction and a transverse direction perpendicular to each other;
a plurality of conductors disposed in the housing, said contacts juxtaposed one another along the transverse direction of said housing with a tiny pitch between every adjacent two conductors;
each of said conductors defining a front mating section and a rear mounting section, and an intermediate section therebetween;
the intermediate section of said conductors arranged with at least first and second levels; wherein
the intermediate sections of a first conductor extends in both said transverse direction and said lengthwise direction to define a rectangle having a transverse dimension cross more than one pitch at the first level;
the intermediate section of a second conductor being not right next to but second next to said one conductor, extends in both said transverse direction and said lengthwise direction to define another rectangle having another transverse dimension cross more than one pitch at the second level; and
the rectangle of the first conductor and the rectangle of the second conductor at least partially overlap with each other in a vertical direction perpendicular to both said lengthwise direction and said transverse direction, for initiating a coupling between the first conductor and the second conductor to somewhat counterbalance another coupling between the first conductor and a third conductor which is between the first conductor and the second conductor.

25. The connector as claimed in claim 24, wherein the intermediate section of the first conductor and the intermediate section of the second conductor are traces formed on at least one printed circuit board connected between the mating sections and the mounting sections of the first and the second conductors.

26. The connector as claimed in claim 24, wherein the said intermediate section of the first conductor is substantially positioned on one side of the first conductor, and the first conductor further includes another intermediate section on the other side thereof to couple with a fourth conductor for counterbalancing coupling between the first conductor and a fifth conductor which is positioned between the first conductor and the fourth conductor.

27. An electrical connector comprising:
an insulative housing defining a lengthwise direction and a transverse direction perpendicular to each other;
eight conductors disposed in the housing and numbered as 1 to 8 in sequence, said contacts juxtaposed one another along the transverse direction of said housing with a tiny pitch between every adjacent two conductors;
each of said conductors defining a front mating section and a rear mounting section, and an intermediate section therebetween;
the intermediate section of said contacts arranged with at least first and second levels; wherein
the intermediate sections of the contacts numbered 1, 4, 5 and 8 are located at the first level, and those of the contacts numbered 2, 3, 6 and 7 are located at the second level.

28. The connector as claimed in claim 27, wherein said intermediate sections at the first level are arranged symmetrical relative a center line thereof along said lengthwise direction.

29. The connector as claimed in claim 27, wherein said intermediate sections at the second level are arranged upside down symmetrical relative to a diagonal thereof.
